(19) United States
(12) Patent Application Publication
(10) Pub. No.: US 2020/0019266 A1
(43) Pub. Date: Jan. 16, 2020

(54) PROTECTION MEMBER AND DISPLAY DEVICE OR TOUCH PANEL INCLUDING PROTECTION MEMBER

(71) Applicant: Mitsubishi Electric Corporation, Tokyo (JP)

(72) Inventor: Hideyo OHTSUKI, Tokyo (JP)

(73) Assignee: Mitsubishi Electric Corporation, Tokyo (JP)

(21) Appl. No.: 16/439,251

(22) Filed: Jun. 12, 2019

(30) Foreign Application Priority Data
Jul. 10, 2018 (JP) 2018-130731

(51) Int. Cl. G06F 3/041; G06F 1/16

(52) U.S. Cl. CPC G06F 3/0412; G06F 1/1626; G06F 1/1643

(57) ABSTRACT

An object is to prevent an occurrence of an air bubble caused by an uneven part around a design print part in a peripheral edge part of a protection member in a protection member which has the design print and is disposed on a display surface of a display device or a touch panel or a display device or a touch panel in which the protection member is disposed.

In a protection member, a design print is formed on a peripheral region in a substrate, a first transparent resin is formed in a region surrounded by the design print, and a second transparent resin is formed to cover the design print and the first transparent resin.

### BACKGROUND OF THE INVENTION

### Field of the Invention

The present invention relates to a protection member including a design print and a display device or a touch panel having the protection member on a display surface side.

### Description of the Background Art

In a display device, a touch panel, and a display device including a touch panel, for example, a protection member is bonded for protecting a display surface in some cases. In bonding the protection member to a display surface of a display panel or a touch panel included in a display device, applied are a structure of attaching the protection member with a double-faced tape and a structure of bonding the protection member using an adhesion bond such as a transparent resin without an air layer therebetween. In the bonding with the transparent resin, for example, a reflected light is reduced at an interface between the air layer and the protection member, thus visibility of the display is improved. A design print is formed in a position in the protection member, the position corresponding to a peripheral edge part of the display device or the touch panel in some cases (for example, Japanese Patent Application Laid-Open No. 2012-88934).

According to an input device described in Japanese Patent Application Laid-Open No. 2012-88934, there is a disclosure that in a protection member in which a design print is formed in a position corresponding to a peripheral edge part, an inclined part is provided in an inner edge of the design print, and an influence of an uneven part of the design print is reduced using a transparent filling material, thereby reducing an occurrence of an air bubble around the design print.

### SUMMARY

However, the input device described in Japanese Patent Application Laid-Open No. 2012-88934 includes a difference in level between the design print part in the protection member and the inclined part (boundary part) in a filling part made up of a transparent resin, for example, so that an air bubble caused by the difference in level occurs in attaching the protection member with the transparent resin in some cases. If the air bubble occurs, a manufacturing yield decreases. Moreover, visibility in the display surface decreases due to the presence of the air bubble.

An object of the present invention is to prevent an occurrence of an air bubble caused by an uneven part around a design print part in a peripheral edge part of a protection member in a protection member which has a design print and is disposed on a display surface of a display device or a touch panel or a display device or a touch panel in which the protection member is disposed.

The present invention is a protection member including: a planar substrate; a design print formed on a peripheral region in one surface of the substrate; a first transparent resin disposed in a region surrounded by the design print and formed to have a thickness equal to or larger than a thickness of the design print; and a second transparent resin laminated on a position having an overlap with the design print and the first transparent resin.

The occurrence of the air bubble can be prevented.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a plan view of a display device including a protection member of an embodiment 1.

FIG. 2 is a cross-sectional view of the display device in FIG. 1 viewed from an A-A direction.

FIGS. 3A to 3C are drawings illustrating a manufacturing process of the protection member of the embodiment 1.

FIG. 4 is a cross-sectional view illustrating a manufacturing process of the display device of embodiment 1.

FIG. 5 is a pattern diagram describing a manufacturing process of the display device of embodiment 1.

FIG. 6 is a cross-sectional view of a display device including a touch panel of the embodiment 1.

FIG. 7 is a cross-sectional view of the protection member of an embodiment 2.

FIGS. 8A to 8C are cross-sectional views illustrating a manufacturing process of the protection member of the embodiment 2.

FIG. 9 is a cross-sectional view of the protection member of the embodiment 2.

### DESCRIPTION OF THE PREFERRED EMBODIMENTS

### Embodiment 1

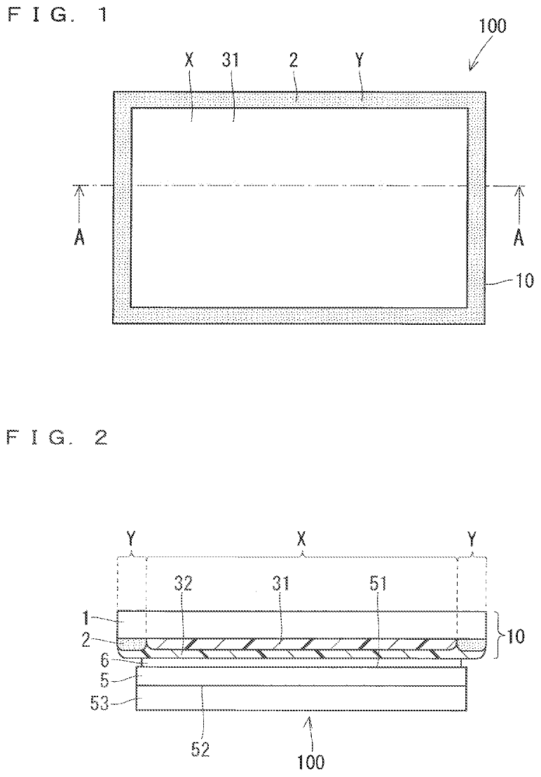

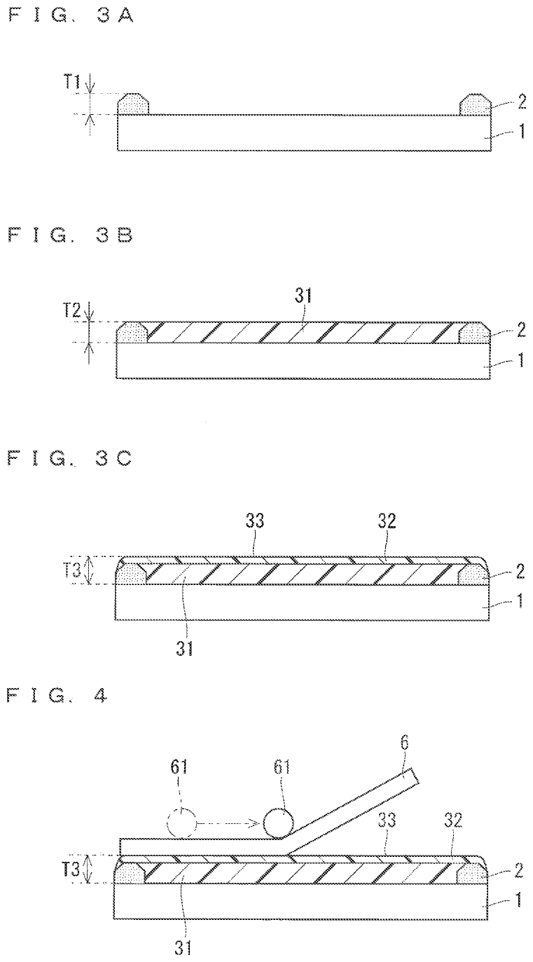

FIG. 1 is a plan view of a display device including a protection member according to an embodiment 1 of the present invention, FIG. 2 is a cross-sectional view of the display device viewed from an A-A direction in FIG. 1, and FIGS. 3A to 3C are drawings illustrating a manufacturing process of the protection member of the embodiment 1.

As illustrated in FIG. 1 or FIG. 2, a display device 100 including a protection member 10 of the present embodiment 1 includes a display panel 5 such as a liquid crystal display panel or an organic EL panel displaying an image, for example. The display panel 5 includes a backlight 53 when a light source is necessary in a position facing an opposite display surface 52 which is a back surface of the display surface 51. The present embodiment 1 describes the display device 100 including the backlight 53. The protection member 10 is disposed on the display surface 51 of the display panel 5. In the protection member 10, a design print 2 is provided on a peripheral region Y in a one surface of which a planar substrate 1 formed of a transparent plate of transparent glass or plastic, for example, and which faces the display surface 51 of the display panel 5.

The design print 2 provided on the protection member 10 has a design adapted to a finished product in manufacturing a product mounting the display device 100 including the display panel 5. The design print 2 is formed with a setting of the peripheral region Y so that a light leaking from a peripheral part of the display device 100 is blocked and the peripheral part of the display device 100 cannot be visually recognized from the protection member 10.

A transparent resin is disposed as a transparent coating material in a region where the design print 2 is not provided on the protection member 10 of the present embodiment 1. That is to say, a first transparent resin 31 is formed in a region X surrounded by the peripheral region Y, and a second transparent resin 32 is formed to be laminated on a region where the design print 2 and the first transparent resin 31 are formed.

A manufacturing method of the protection member 10 of the present embodiment 1 is described using FIGS. 3A to 3C. As illustrated in FIG. 3A, in the protection member 10 of the present embodiment 1, the design print 2 is formed on the peripheral region Y on the one surface of the substrate 1 constituting the protection member 10. The design print 2 can be formed by various methods such as screen printing, ink-jet printing, gravure printing, off-set printing, a transfer method, and an evaporation method. When the design print 2 is formed using a black ink or a material containing a black ink, a thickness T1 of the design print 2 is 8 to 15 μm, for example. When the design print 2 is formed with a material having a light color such as a white ink or an ink material including white color through which the light easily passes, the material needs to be formed (applied) to be thick enough, compared with the case of using the black ink, so that the light does not pass through the material, and is formed to have the thickness T1 ranging from 15 to 30 μm.

Next, a transparent resin is formed on the substrate 1 as a transparent coating material. The transparent resin is formed in two steps in the protection member 10 of the present embodiment 1. Firstly, as illustrated in FIG. 1, FIG. 2, and FIG. 3B, in the surface of the substrate 1 on which the design print 2 is formed, a printing is performed in the region X where the design print 2 is not formed, that is to say, the region X surrounded by the region Y where the design print 2 is formed, with a setting of a thickness T2 of the first transparent resin 31 having a thickness equal to or larger than the thickness T1 of the design print 2 (a first step).

When the thickness T2 of the first transparent resin 31 is larger than the thickness T1 of the design print 2, the first transparent resin 31 is protruded by approximately 1 to 2 μm in a thickness direction, for example. When the design print 2 is performed with a black ink having the thickness T1 of approximately 10 μm, the thickness T2 of the first transparent resin 31 is set to 10 in. Alternatively, the first transparent resin 31 is formed to have the thickness T2 ranging 10 to 12 μm, including a case where the first transparent resin 31 has a thickness larger than the thickness T1 by 1 to 2 μm (T1≤T2). When the first transparent resin 31 is formed in such a manner, the protection member 10 is covered by the design print 2 and the first transparent resin 31 on the one surface, thus a formation of a difference in level or a boundary between the thickness T1 of the design print 2 and the thickness T2 of the first transparent resin 31 can be prevented.

Next, as illustrated in FIG. 3C, a second transparent resin 32 is formed to have an overlap with the design print 2 and the first transparent resin 31. The second transparent resin 32 is formed to cover the whole design print 2 and first transparent resin 31. If the difference in level or the boundary occurs between the design print 2 and the first transparent resin 31, the second transparent resin 32 laminated in such a manner can absorb the difference in level or the boundary. The total thickness of the first transparent resin 31 and the second transparent resin 32 is T3. The structure of covering the whole design print 2 and first transparent resin 31 by the second transparent resin 32 is applied even when the difference in level or the boundary is not formed. Accordingly, a surface 33 which is the one surface of the protection member 10 can be flattened. The transparent coating using the second transparent resin 32 is performed by one process on the one surface of the protection member 10, thereby being able to achieve a finish preventing the difference in level or the boundary (joint part). As described above, the second transparent resin 32 absorbs the difference in level and the boundary between the design print 2 and the first transparent resin 31 and covers the whole, thus the formation of the difference in level on the second transparent resin 32 is prevented on the one surface of the protection member 10, and the flattened surface can be formed.

An acrylic resin, for example, can be used as the first transparent resin 31 and the second transparent resin 32. Alternatively, a photo-curable transparent liquid resin may be used. The first transparent resin 31 and the second transparent resin 32 may be formed of the same material, or different materials may also be applied. When the resins made up of the different materials are used, for example, when the different materials are selected and an enamel resin is applied on a lacquer resin, the second transparent resin 32 can prevent the first transparent resin 31 from seeping into the second transparent resin 32. Particularly, when a solvent of the resin of the design print 2 and the resin of the first transparent resin 31 and the second transparent resin 32 are made of the different materials, the design print 2 can be prevented from seeping into the first transparent resin 31 and the second transparent resin 32.

In the present embodiment 1, the first transparent resin 31 and the second transparent resin 32 are made up of a resin-based resin, however, the material is not limited thereto, and the equivalent effect can also be obtained with a transparent inorganic material such as SiO₂.

Described next is a step of bonding the protection member 10 of the present embodiment 1 to the display surface 51 of the display panel 5. FIG. 4 is a diagram illustrating a process of attaching a transparent adhesion bond 6 having a sheet-like shape, that is a gel-like transparent adhesive sheet, to the protection member 10 and a manufacturing process of the display device, and FIG. 5 is a drawing illustrating a step of attaching the protection member 10 in FIG. 4 to the display panel 5 in a vacuum chamber 80.

As illustrated in FIG. 4, when the transparent adhesion bond 6 is attached to the protection member 10, a separator (not shown) disposed on one surface of the transparent adhesion bond 6 is removed under ordinary pressure, and the one surface of the transparent adhesion bond 6 is attached to the second transparent resin 32 (to face the surface 33) while rolling a roller 61, for example.

Next, in the vacuum chamber 80 illustrated in FIG. 5, a display module including the display panel 5 is put on a receptacle table 81 disposed in the vacuum chamber 80. In the protection member 10, the transparent adhesion bond 6 attached to the protection member 10 faces the display surface 51 of the display panel 5, and they are disposed in a protection member suction chuck 82. Subsequently, the vacuum chamber 80 is maintained as a vacuum, and the display panel 5 is lifted in a direction of an arrow D, thereby bonding the transparent adhesion bond 6 on the protection member 10 to the display surface 51 of the display panel 5.

The step of attaching the transparent adhesion bond 6 to the protection member 10 in FIG. 4 is performed under ordinary pressure, so that if there is even an extremely small uneven part at the time of attaching the transparent adhesion bond 6 to the protection member 10, the uneven part cannot be closely attached, and the air bubble occurs in some cases. In the present embodiment 1, the display panel 5 and the transparent adhesion bond 6 of the protection member 10 are bonded in the vacuum chamber 80, that is to say, in a vacuum. Thus, the presence and the occurrence of the air bubble between the protection member 10 and the transparent adhesion bond 6 can be prevented.

As described above, according to the present embodiment 1, in the protection member 10, the design print 2 is formed on the peripheral region Y in the substrate 1, the first transparent resin 31 is formed in the region X surrounded by the design print 2, and the second transparent resin 32 is formed to cover the design print 2 and the first transparent resin 31. Thus, the second transparent resin 32 can absorb the difference in level and the boundary between the design print 2 and the first transparent resin 31, and the formation of the difference in level can be prevented on the surface of the protection member 10 where the design print 2 is formed. Thus, the air bubble occurring around the design print 2 can be prevented.

The display device 100 of the present embodiment 1 has a structure of bonding the protection member 10 to the display surface 51 of the display panel 5 with the transparent adhesion bond 6, thus the air bubble occurring around the design print 2 is prevented, and the decrease in the manufacturing yield of the display device 100 can be prevented. Since the present embodiment 1 has a structure capable of preventing the occurrence of the air bubble, the decrease in the visibility in the display device 100 is prevented.

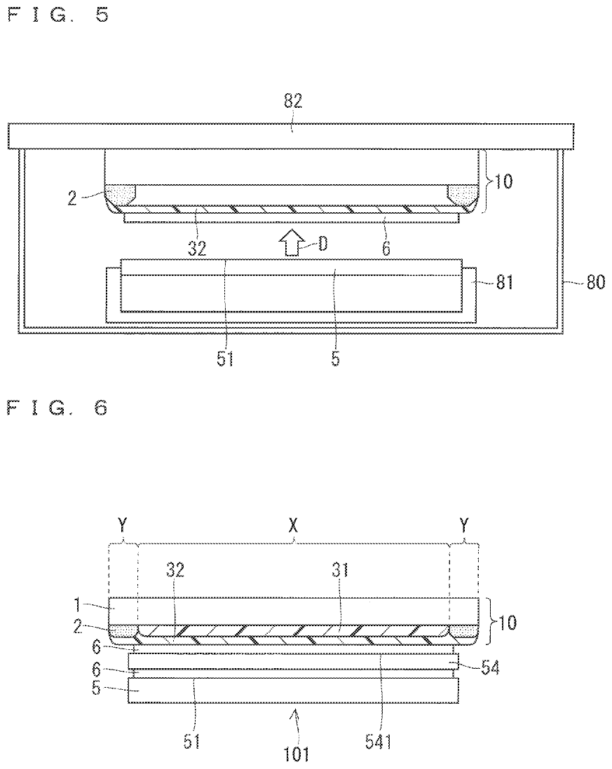

As shown in a cross-sectional view of a display device 101 with a touch panel in FIG. 6, a touch panel 54 may be provided. The touch panel 54 is disposed to face the display surface 51 of the display panel 5, and the protection member 10 is disposed on a display surface 541 of the touch panel via the transparent adhesion bond 6.

### Embodiment 2

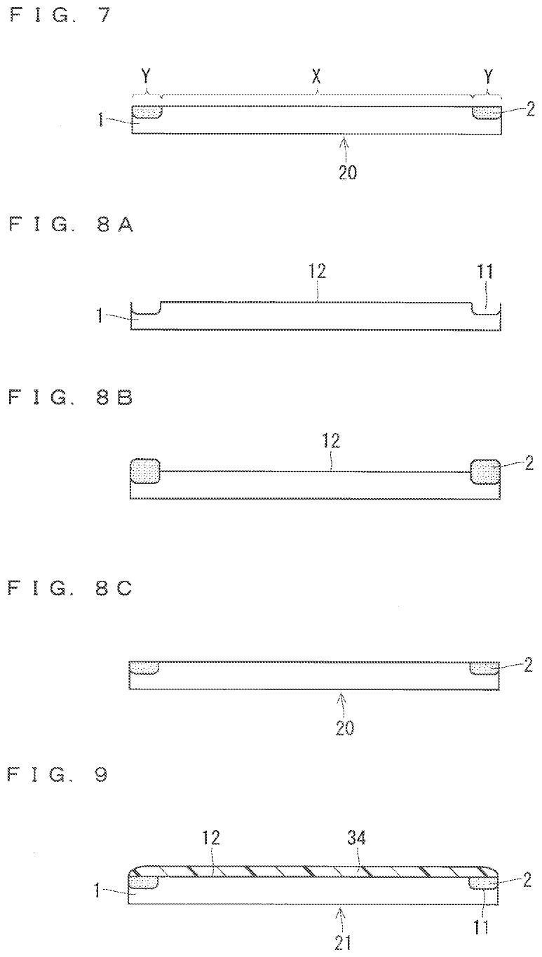

FIG. 7 is a cross-sectional view of a protection member 20 according to an embodiment 2 of the present invention, and FIGS. 8A to 8C are drawings illustrating a manufacturing process of the protection member in the embodiment 2. In the embodiment 1, the first transparent resin 31 is formed in the region X surrounded by the region Y where the design print 2 is formed, and the second transparent resin 32 is formed to be laminated on the design print 2 and the first transparent resin 31, however, in the embodiment 2, the region Y where the design print 2 is disposed is formed in a concave part 11 in the substrate 1 as illustrated in FIG. 7.

A method of forming the protection member 20 in the embodiment 2 is described using FIGS. 8A to 8C. As illustrated in FIG. 8A, in an upper surface 12 which is one surface of the protection member 20, the concave part 11 is formed to have a concave shape toward a depth direction from the upper surface 12, corresponding to the peripheral region Y (refer to FIG. 7). The concave part 11 can be formed by filing the peripheral region Y in the substrate 1 with a file, for example, however, a method of manufacturing the concave part 11 can be appropriately selected.

Next, the design print 2 is disposed in the concave part 11 as illustrated in FIG. 8B. A method of forming the design print 2 can be selected from screen printing, ink-jet printing, gravure printing, off-set printing, a transfer method, and an evaporation method, for example. When the design print 2 is disposed in the concave part 11, the design print 2 has a convex structure of being raised with respect to the upper surface 12 of the substrate 1 in the protection member 20.

Next, as illustrated in FIG. 8C, the design print 2 is pared off to have a height equivalent to a height of the upper surface 12. A means of paring the design print 2 can be selected from cutting and sandblasting after mask processing, for example. Although depending on a type of the printing, polishing process may also be applied as well as paring, and it is also applicable to wipe a print material in an unhardened state.

The protection member 20 of the present embodiment 2 can prevent the occurrence of the difference in level and the boundary between the design print 2 and the upper surface 12.

FIG. 9 is a cross-sectional view of a protection member 21 according to a modification example of the present embodiment 2. In the present modification example, as illustrated in FIG. 9, a third transparent resin 34 is laminated to have an overlap with the upper surface 12 and the design print 2 formed in the concave part 11. The third transparent resin 34 is laminated to have an overlap with the design print 2 and the upper surface 12, thereby being able to absorb the difference in level and the boundary between the design print 2 and the upper surface 12 to prevent the air bubble occurring around the design print 2 and protect the upper surface 12 of the protection member 20 with the transparent resin, thus the occurrence of the difference in level and the boundary between the design print 2 and the upper surface 12 can be prevented more reliably. The protection member 20 or 21 may be bonded to the display panel 5 or the touch panel 54 using a transparent resin, as the protection member 10 or 11.

The above embodiments describe the structure of locating the display surface 51 of the display panel 5 to face the protection member and bonding the display surface 51 to the protection member (10, 11, 20, or 21) with the transparent adhesion bond 6, however, a configuration of attaching the protection member with a double-faced tape can also be applied as the method of bonding the protection member as well as bonding it with the transparent adhesion bond. The protection member having a rectangular shape is shown in the drawings, however, a shape other than the rectangular shape can also be applied in the present embodiments. As described above, each embodiment can be combined within the scope of the invention.

While the invention has been shown and described in detail, the foregoing description is in all aspects illustrative and not restrictive. It is therefore understood that numerous modifications and variations can be devised without departing from the scope of the invention.

What is claimed is:

1. A protection member, comprising:
a planar substrate;
a design print formed on a peripheral region in one surface of the substrate;
a first transparent resin disposed in a region surrounded by the design print and formed to have a thickness equal to or larger than a thickness of the design print; and
a second transparent resin laminated on a position having an overlap with the design print and the first transparent resin.

2. A protection member, comprising:
a planar substrate;
a concave part formed in a peripheral region in one surface of the substrate; and
a design print formed in the concave part to have a height equal to a height of the one surface of the substrate.

3. The protection member according to claim 2, further comprising a transparent resin laminated on a position having an overlap with the one surface of the substrate and the design print.

4. A display device, comprising:
a display panel displaying an image; and
a protection member according to claim 1 facing a display surface of the display panel.

5. A touch panel, comprising:
a touch panel; and
a protection member according to claim 1 facing one surface of the touch panel.

6. A display device, comprising:
a display panel displaying an image; and
a protection member according to claim 2 facing a display surface of the display panel.

7. A touch panel, comprising:
a touch panel; and
a protection member according to claim 2 facing one surface of the touch panel.

8. The display device according to claim 4, wherein
the protection member and the display panel are bonded using a transparent resin.

9. The touch panel according to claim 5, wherein
the protection member and the touch panel are bonded using a transparent resin.
